(19) United States
(12) Patent Application Publication
(10) Pub. No.: US 2004/0158619 A1
(43) Pub. Date: Aug. 12, 2004

(54) Method and apparatus for provisioning content

(76) Inventors: Claus Pedersen, Copenhagen (DK); Alexander Piorecki, Copenhagen (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/360,752

(22) Filed: Feb. 10, 2003

(51) Int. Cl. G06F 15/16

(52) U.S. Cl. 709/219

(57) ABSTRACT

A method of processing a received provisioning document to enable access by a client to a resource is described. A provisioning document, comprising a first parameter value that identifies the content of a resource and at least a second parameter value for accessing the resource, is received. A new user selectable menu item in a menu structure is created. The position of the menu item within the menu structure is dependent upon at least the first parameter value. At least the third parameter value is automatically stored, so that it can be used by the client when the user selects the new menu item. Also described is a method of validating pushed messages received at a client and a method of assigning an identifier for a configuration context.

### TECHNICAL FIELD

The present invention relates to provisioning of a mobile internet client. One type of mobile internet client is a wireless application protocol (WAP) client. Another type of mobile internet client is an i-Mode client. Consequently, embodiments of the invention include, but are not limited to, provisioning of a WAP client.

### BACKGROUND TO THE INVENTION

The Open Mobile Alliance currently controls the Wireless Application Protocol (WAP). A number of specification documents have been published, which define how WAP should operate. These specifications include Provisioning Content Specification V1.1 (Draft Version 20 Sep. 2002) and WAA-(WAP)189-PushOTA. A wireless application protocol (WAP) network comprises a number of clients, servers and proxy gateways that mediate between a client and server.

WAP supports “pull” and “push” technology. In “pull” technology, a client requests a service or information from a server, which then responds by transmitting information to the client. Browsing the World Wide Web is a typical example of pull technology. In “push” technology, the server sends information to the client without an explicit request i.e. it is server initiated.

Provisioning is the process by which the client is configured with a minimum of user interaction on receipt of a provisioning document. A Trusted Provisioning Server (TPS) is a source of provisioning documents containing information that can be trusted by a client. A configuration context is a set of connectivity and application configurations associated with that TPS. A configuration context is therefore ‘owned’ by the owner of the TPS. Provisioning documents may also be pushed from other servers.

A current problem is that malicious messages may be pushed to WAP clients. For example, a mobile phone client may be controlled by a pushed document, to make data calls. It would be desirable to reduce the risk from pushed malicious messages.

Another problem is that there is no standardised mechanism by which a client identifies a configuration context. It is therefore currently necessary for each client manufacturer to have there own proprietary method. It would be desirable to define a mechanism that all clients can use to identify the configuration context.

Another problem is that a current WAP client made by a particular manufacturer (e.g. a particular model of mobile phone) may be used in many different applications (e.g. different cellular networks). At present if the client is to be configured in a manner dependent upon its application, then this generally occurs at the point of manufacture or manually at or after the point of sale. It would also be desirable to define a mechanism that can be used to configure a WAP client automatically so that it can access or offer access to particular resources dependent upon its application, after the point of sale. As an example, the operator of a cellular network could automatically configure the clients used in his network to have access to particular resources such as games, ring tones and screen savers.

### BRIEF SUMMARY OF THE INVENTION

According to one embodiment of the invention there is provided a method of processing a received provisioning document to enable access by a client to a resource, comprising the steps of: a) receiving a provisioning document comprising a first parameter value that identifies the content of a resource and at least a second parameter value for accessing the resource; b) automatically creating a new user selectable menu item in a menu structure wherein the position of the menu item within the menu structure is dependent upon at least the first parameter value; and c) automatically storing at least the third parameter value, so that it can be used by the client when the user selects the new menu item.

According to another embodiment of the invention there is provided a method of provisioning a media resource in a client, comprising the step of: sending a provisioning document to the client, wherein the provisioning document comprises a first parameter value that identifies the content of the media resource and at least a second parameter value for accessing the resource.

According to a further embodiment of the invention there is provided a method of validating pushed messages received at a client, comprising the steps of:

(i) storing the addresses of trusted physical push proxy gateways; and

(ii) determining whether or not to accept a received push message by comparing the address of the received push message with the stored addresses.

According to a further embodiment of the invention there is provided a method of assigning an identifier for a configuration context, comprising the steps of: a) Parsing a bootstrap configuration document for creating a first configuration context; b) identifying the value of the parameter NAME of the BOOTSTRAP characteristic; and c) assigning the identified value as the identifier of the first configuration context.

According to a further embodiment of the invention there is provided a client comprising a displayable menu of user selectable items, wherein the client is arranged to: receive a provisioning document comprising a first parameter identifying the content of a resource and at least a second parameter value for enabling the client to access a remote resource; to create a new user selectable menu item in a menu structure wherein the position of the menu item within the menu structure is dependent upon at least the first parameter; and to store at least the third parameter value, so that it can be used by the client when the user selects the new menu item.

### BRIEF DESCRIPTION OF THE DRAWINGS

For a better understanding of the present invention and to understand how the invention can be practised reference will now be made by way of example only to the accompanying drawings of embodiments of the invention in which:

FIG. 1 illustrates an example of a wireless application protocol (WAP) network;

FIG. 2 illustrates a process for validating, at a client, a received push message;

FIG. 3 illustrates a process for obtaining an identifier of a configuration context; and

FIG. 4 illustrates the process by which a client can be provisioned with a multimedia resource.

### DETAILED DESCRIPTION OF EMBODIMENTS(S) OF THE INVENTION

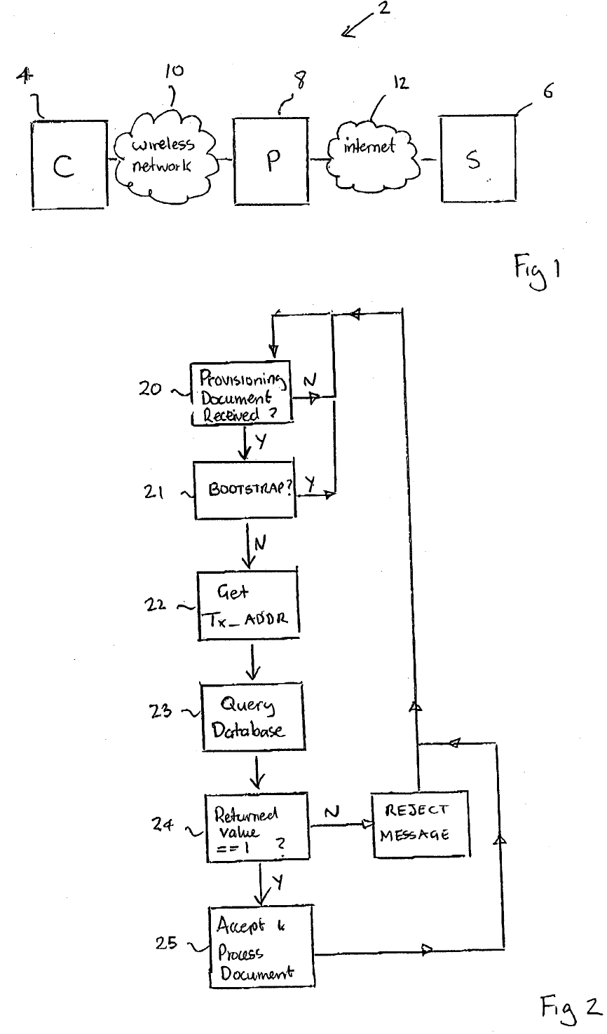

FIG. 1 illustrates a wireless application protocol (WAP) network 2 comprising a client 4, a server 6 and a proxy gateway 8 that mediates between the client 4 and server 6. In this example, the client 4 is a mobile radio telecommunications device operating in a wireless network 10 and the server 6 is part of the internet 12.

WAP supports “pull” and “push” technology. In “pull” technology, the client 4 requests a service or information from the server 6, which then responds by transmitting information to the client 4. Browsing the World Wide Web is a typical example of pull technology. In “push” technology, the server 6 sends information to the client 4 without an explicit request i.e. it is server initiated. In the example of FIG. 1 the proxy gateway 8 is a push proxy gateway and allows the server 6 to push information to the client 4.

The proxy gateway 8 may be located in a number of places, including under the control of the operator of the wireless network 10, in order to provide feature enhancements coupled to the wireless network e.g. provisioning.

Provisioning is the process by which the client 4 is configured with a minimum of user interaction. The term covers both over the air (OTA) provisioning and provisioning by means of, e.g. smart cards. The client 4 may, for example, be provisioned with connectivity and application information by pushing configuration parameters contained in a provisioning document over the air from the server 6 to the client 4.

A provisioning document is a binary encoded XML document with a special MIME type that is interpreted at the application level of the client 4. The XML Document Type Definition (DTD) for a provisioning document defines two elements: a parm element, which is used to provide values for the individual parameters; and a characteristic element, which is used to group parameters into logical entities.

A Trusted Provisioning Server (TPS) is a source of provisioning documents containing information that can be trusted by a client. A Configuration Context is a set of connectivity and application configurations associated with that TPS. Provisioning documents may also be pushed from other servers, but these will not be trusted.

Push Validation

The client 4 validates a pushed provisioning document before accepting and processing it.

The client 4 receives a provisioning document from a trusted provisioning server 6 having the following characteristics and parameters:

Characteristic: PXLOGICAL

{

. . .

Characteristic: PXPHYSICAL

(

. . .

parm: PXADDR

. . .

parm: PUSHENABLED

. . .

}

. . .

}

The PXLOGICAL characteristic includes parameters and characteristics that define the logical proxies. It includes at least one characteristic PXPHYSICAL that defines the physical WAP proxy entity, the push proxy gateway 8 in this example. The PXPHYSICAL characteristic includes the parameters PXADDR and PUSHENABLED. The parameter PXADDR is the address of the physical WAP proxy entity. The parameter PUSHENABLED identifies whether the physical proxy is a push proxy or not. The parameter PUSHENABLED takes the vale 0 or 1. If the value is 1 for a given physical proxy, this physical proxy will support push, as in FIG. 1. If the value is 0 for a given physical proxy, this proxy will not support push.

The client 4 automatically creates a database of trusted push proxies using the information in the received provisioning document. The client 4 parses the one or more PXPHYSICAL characteristics. For each PXPHYSICAL characteristic the client creates a database entry. The entry stores the value of the parameter PXADDRR and the value of the parameter PUSHENABLED. The value of PXADDRR and the value of PUSHENABLED are associated, so that querying the database using the value of PXADDRR returns the value of PUSHENABLED.

The database may also be manually configured.

A relationship of trust exists between a client 4 and a trusted provisioning server (TPS). The push proxies identified by the TPS using the provisioning document are consequently treated as trusted push proxies.

FIG. 2 illustrates the process for validating, at a client, a received push message. When the client receives a pushed message, the process moves from step 20 to step 21. At step 21, the client checks whether the pushed message is a bootstrap provisioning document. Such a document will have the BOOTSTRAP characteristic at its root. If the pushed document is a bootstrap provisioning document, the process returns to step 20. Otherwise, it proceeds to step 22. At step 22, the client identifies the address (Tx_ADDR) of the originator of the message. If a non IP bearer is used then Tx_ADDR is taken from the bearer protocol e.g. in SMS it is taken from the SMS headers. If an IP bearer is used (e.g. GPRS), then Tx_ADDR is taken from the User Datagram Protocol (UDP). The client then proceeds to step 23, where the database is queried using TX_ADDR. Next, at step 24, the return value from the database is checked. If it is equal to “1” the process moves to step 25, otherwise it moves to step 26. At step 26, the received push message is rejected and the process returns to step 20. At step 25, the received push message is automatically accepted and processed and the process then returns to step 20.

The database will return value of “1”, if there is an entry for a PXADDRR the same as Tx_ADDR, and the value of the associated PUSHENABLED parameter is “1”. The database will not return a value of “1” if there is not an entry for a PXADDRR the same as Tx_ADDR. The database will return value of “0”, if there is an entry for a PXADDRR the same as Tx_ADDR, and the value of the associated PUSHENABLED parameter is “0”.

The term “automatic” is used to denote acceptance without any or minimal user intervention. If a pushed message has not been automatically accepted, the client, according to one embodiment, allows the user to manually accept the pushed message. The user is presented with a user selectable option to accept the pushed message. The option preferably identifies the configuration context (in the manner described below) with which the proxy, that has pushed a message to the client is associated (if any) and asks the user whether or not the user wishes to manually accept the pushed message. A warning may be displayed regarding the dangers of accepting push messages from unknown sources.

Configuration Context Identification

The client 4 is capable of automatically creating a context database from a received bootstrap provisioning document that can be used to identify a configuration context by name. E.g. using the name of the wireless network operator controlling the TPS that sent the bootstrap provisioning document.

The process first tries to use the name of the configuration context from the bootstrap configuration and if this fails it tries to use the URI from PROVURL and if this fails it tries to use some other name, for example, the name of the physical proxy.

The bootstrap provisioning document contains the BOOTSTRAP characteristic at the root of the provisioning document. The document may also include (amongst other characteristics) the PXLOGICAL characteristic.

e.g.

characteristic: BOOTSTRAP

{

parm: NAME

. . .

parm: PROVURL

. . .

}

characteristic: PXLOGICAL

{

. . .

parm: NAME

. . .

}

The BOOTSTRAP characteristic defines parameters for use during the bootstrap process. It includes the parameter NAME, which is a logical, user readable, identity of the configuration context and it also includes the parameter PROVURL, which is the URL to be used to contact the trusted provisioning server (TPS). PROVURL is a unique identifier of the configuration context. The PXLOGICAL characteristic includes parameters and characteristics that define the logical proxies. The NAME parameter in the PXLOGICAL characteristic indicates a logical, user readable, identity of the physical proxy.

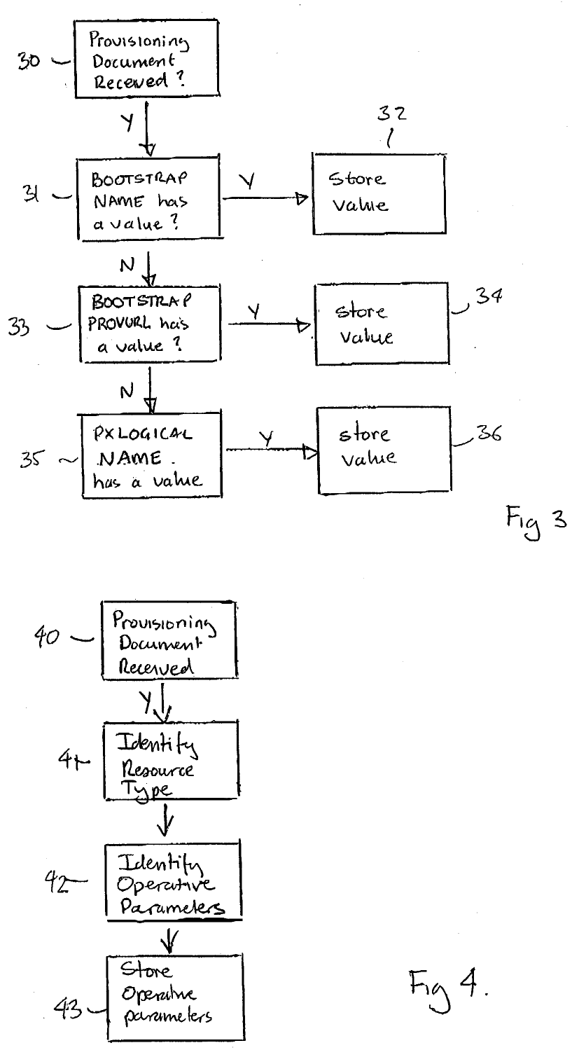

The client 4 parses the bootstrap provisioning document to obtain a name for the configuration context enabled by that bootstrap provisioning document. The process of obtaining an identifier of a configuration context, that can be understood by a user, is illustrated in FIG. 3. At step 30, the client determines whether or not it has received a bootstrap provisioning document. If it has, control moves to step 31.

At step 31, the client 4 checks whether the NAME parameter in the BOOTSTRAP characteristic has a value. If it does control moves to step 32, if it does not control moves to step 33. At step 32, the value of the NAME parameter is stored in memory as the name of the configuration context created by the bootstrap process. After storing the value control returns to step 30.

At step 33, the client 4 checks whether the PROVURL parameter in the BOOTSTRAP characteristic has a value. If it does control moves to step 34, if it does not control moves to step 35. At step 34, the value of the PROVURL parameter is stored in memory as the name of the configuration context created by the bootstrap process. After storing the value control returns to step 30.

At step 35, the client checks for another name of the configuration context. As an example, it may check whether the NAME parameter in the PXLOGICAL characteristic has a value. If it does control moves to step 36, if it does not control moves to step 30. At step 36, the value of the NAME parameter is stored in memory as the name of the configuration context created by the bootstrap process. After storing the value control returns to step 30.

Thus the process first tries to use a word or phrase as the identifier for the configuration context. It first tries to use the name of the configuration context from the bootstrap configuration and if this fails it tries to use the URI from PROVURL and if this fails it tries to use some other name, for example, the name of the physical proxy.

The value representing the name of the configuration context may be stored in a management tree, which is a hierarchical data structure.

When a configuration context needs to be identified to a user, the value representing the name of the configuration context is recalled from the memory and displayed on a display.

Provisioning resources automatically

A provisioning document may allow a client 4 to be customised to a particular specification. For example, the provisioning document may enable the client to automatically download identified content to configure the client and/or it may provide menu options, selectable by a user, for download of content to configure the client.

In this way, ringing tones, screen savers, etc can be customised without having to adapt the phones at manufacture or manually at the point of sale. This gives an operator of a wireless network 10 the opportunity to brand the clients 4 they supply, by customising them using provisioning. This provisioning may occur when the client is first switched on in the wireless network 10 using a bootstrap provisioning document or later.

Three new types of application service are specified for provisioning documents:

1) configuration_application;

2) download_application; and

3) upload_application.

The configuration_application enables the client to automatically download identified resources tó configure the client. The provider of the provisioning document can therefore automatically configure the content used in the client.

The download_application provides selectable menu options, selectable by a user, for downloading content to the client. The selection of an option downloads the identified resource's content to the client.

The upload_application provides selectable options for upload to the user of the client. The selection of an option uploads the identified content from the client.

A provisioning document for the configuration_application service contains:

<characteristic type=“APPLICATION”>

<parm name=“APPID” value=“configuration_application”/>

. . .

<characteristic type=“RESOURCE”>

<parm name=“AAUTHNAME” value=“username”/>

<parm name=“AAUTHSECRET” value=“password”/>

<parm name=“URI” value=“www.operator.com/operatorlogo/index.wml ”/>

<parm name=“NAME” value=“Operator Logo ”/>

<parm name=“AACEPT” value=“tokenised value of operator logo; versions supported ”/>

</characteristic>

</characteristic>

A provisioning document for the download-application service contains:

<characteristic type=“APPLICATION”>

<parm name=“APPID” value=“configuration_application”/>

. . .

<characteristic type=“RESOURCE”>

<parm name=“AAUTHNAME” value=“username”/>

<parm name=“AAUTHSECRET” value=“password”/>

<parm name=“URI” value=www.operator.com/ringtonedownload/index.wml ”/>

<parm name=“NAME” value=“Operator Ringingtone ”/>

</characteristic>

</characteristic>

The APPLICATION characteristic provides parameters that a WAP client needs to access a particular application service access point. The APPID identifies the type of the application service available.

The RESOURCE characteristic indicates the available resources and their access parameters within the APPLICATION characteristic. The AAUTHNAME parameter is optional and, if present, provides the id (plaintext) used in authenticating the user e.g. the log-on user ID. The AAUTHSECRET parameter is optional and, if present, provides the authentication secret used in authenticating the user e.g. the log-on user password. The URI parameter specifies the value used to identify the resource in the application protocol. The NAME parameter indicates a user readable identity of the RESOURCE. The AACCEPT parameter, if present, is normally used to list the content types.

FIG. 4 illustrates the process by which a client can be provisioned with a multimedia resource. The client 4 receives the provisioning document at step 40 of FIG. 4 and moves to step 41. The provisioning document contains one or more of the new application services: configuration_application, download_application and upload_application.

At step 41, the client parses the provisioning document and identifies the APPLICATION characteristic. The client parses the APPLICATION characteristic and identifies the value of the APPID parameter in the APPLICATION characteristic. This value identifies the application service. It may have the value “configuration_application”, “download_application” or “upload_application”. The process then moves to step 42.

At step 42, the client parses the RESOURCE characteristic and identifies the values of the operative parameters of the resource. The operative parameters are those necessary to identify and access the resource. They include the value of the URI parameter and the value of the NAME parameter (and also AAUTHNAME and AAUTHSECRET, if present). The client stores the operative parameter values URI and NAME (and also AAUTHNAME and AAUTHSECRET, if present) at step 43.

The combination of the value of APPID and NAME in the example given above for configuration_application service indicates that the resource is a logo for configuring the client. The combination of the value of APPID and NAME in the example given above for download_application service indicates that the resource is an index of ringing tones for downloading to the client.

The operative parameters from the configuration_application service are used to automatically configure the client by accessing the identified URI. The operative parameters from the download_application service or the configuration_application service may be stored at a leaf node of a data management tree. A management tree is a hierarchical data structure formed from interconnected nodes. A node can be a branch node that has leaf node(s) or branch node(s) depending from it or a leaf node, which has no dependent nodes. A leaf node can store data values, whereas a branch node cannot. A particular combination of values for APPID and NAME identifies a particular branch node in the management tree.

When a provisioning document with a new combination of APPID and NAME is received, a new leaf node is made. The new leaf node depends from the branch node defined by the received APPID and NAME combination. The new leaf node is used to store the operative parameters of the new resource obtained from the provisioning document.

There may be, for example, a particular branch node for “download ring tones“associated with the APPID, NAME pair ‘download_application’ and ‘Operator Ringingtone’. The new leaf node depending from the branch node contains the values of AAUTHNAME, AAUTHSECRET, URI and ACCEPT. There may also be for example, nodes for “links to download screensavers”, “links to download games”, “upload game scores” etc. associated with different APPID, NAME pairs.

The client 4 has a user navigable menu structure corresponding to the management tree or portions of the management tree. The creation of a new leaf node may correspond to the creation of a new user-selectable item in the menu structure. The new item is selected by navigating to an option corresponding to the new leaf node and selecting it. This option has an identifier of the menu item (e.g. NAME stored in the leaf node). Consequently, the creation of a new leaf node creates a new item in the menu structure.

Although embodiments of the present invention have been described in the preceding paragraphs with reference to various examples, it should be appreciated that modifications to the examples given can be made without departing from the spirit and scope of the invention.

I/we claim:

1. A method of processing a received provisioning document to enable access by a client to a resource, comprising the steps of:
a) receiving a provisioning document comprising a first parameter value that identifies the content of a resource and at least a second parameter value for accessing the resource;
b) automatically creating a new user selectable menu item in a menu structure wherein the position of the menu item within the menu structure is dependent upon at least the first parameter value; and
c) automatically storing at least the second parameter value, so that it can be used by the client when the user selects the new menu item.

2. A method as claimed in claim 1, wherein the first parameter value is the value of NAME of the RESOURCE characteristic.

3. A method as claimed in claim 1, wherein the second parameter value is the value of URI of the RESOURCE characteristic.

4. A method as claimed in claim 1, wherein the provisioning document additionally comprises a third parameter, and wherein the position of the menu item within the menu structure is dependent upon the first parameter value and the third parameter value.

5. A method as claimed in claim 4, wherein the third parameter value is the value of APPID of the APPLICATION characteristic.

6. A method as claimed in any one of claims 1 to 5, further comprising the step of validating a received provisioning document that has been pushed to the client.

7. A method as claimed in claim 6, wherein the validation of the received provisioning document includes the steps of:
(i) storing the addresses of trusted physical push proxy gateways; and
(ii) determining whether or not to accept a received pushed provisioning document by comparing the address of the received push message with the stored addresses.

8. A method of provisioning a media resource in a client, comprising the step of: sending a provisioning document to the client, wherein the provisioning document comprises a first parameter value that identifies the content of the media resource and at least a second parameter value for accessing the resource.

9. A client comprising a displayable menu of user selectable items, wherein the client is arranged:
to receive a provisioning document comprising a first parameter identifying the content of a resource and at least a second parameter value for enabling the client to access a remote resource;
to create a new user selectable menu item in a menu structure wherein the position of the menu item within the menu structure is dependent upon at least the first parameter; and
to store at least the third parameter value, so that it can be used by the client when the user selects the new menu item.

10. A method of validating pushed messages received at a client, comprising the steps of:
(i) storing the addresses of trusted physical push proxy gateways; and
(ii) determining whether or not to accept a received push message by comparing the address of the received push message with the stored addresses.

11. A method as claimed in claim 10, further comprising the step of:
obtaining the address of a trusted physical push proxy gateway from a received provisioning document.

12. A method as claimed in claim 11, wherein the obtaining step further comprises the step of:
parsing the provisioning document and identifying a first parameter value representing the address of a physical proxy gateway and a second parameter value indicative of whether the proxy gateway is a push proxy gateway.

13. A method as claimed in claim 12, wherein the first parameter value is the value of PXADDRR of the PXPHYSICAL characteristic.

14. A method as claimed in claim 13, wherein the second parameter value is the value of PUSHENABLED of the PXPHYSICAL characteristic.

15. A method as claimed in claim 10, wherein step (i) comprises manually storing an address of a physical push proxy as the address of a trusted physical push proxy.

16. A method of assigning an identifier for a configuration context, comprising the steps of:
a) Parsing a bootstrap configuration document for creating a first configuration context;
b) identifying the value of the parameter NAME of the BOOTSTRAP characteristic; and
c) assigning the identified value as the identifier of the first configuration context.

17. A method as claimed in claim 16, wherein in the event that a value is not identified in step b), performing the step of: identifying the value of the parameter PROVURL of the BOOTSTRAP characteristic.
